(19) United States
(12) Patent Application Publication
(10) Pub. No.: US 2006/0080701 A1
(43) Pub. Date: Apr. 13, 2006

(54) Television serving system capable of sending video/audio signals to terminals

(75) Inventors: Pai-Chuan Yueh, Kuei Shan Hsiang (TW); Ming-Jen Hsu, Kuei Shan Hsiang (TW)

Correspondence Address: TROXELL LAW OFFICE PLLC, SUITE 1404, 5205 LEESBURG PIKE, FALLS CHURCH, VA, 22041, US

(73) Assignee: Sampo Corporation

(21) Appl. No.: 10/959,158

(22) Filed: Oct. 7, 2004

(51) Int. Cl. H04N 7/16; H04N 7/10

(52) U.S. Cl. 725/28; 725/30; 725/25; 725/34

(57) ABSTRACT

A television serving system capable of sending video/audio signals to terminals is provided. The television serving system includes a parent television connecting to a video/audio signal broadcasting device and receiving at least one video/audio signal outputted from the video/audio signal broadcasting device, a child television, and a signal transmission interface connected to the parent television and the child television and serving as a video/audio signal transmission channel between the parent television and the child television. Parents are capable of controlling programs broadcasted on the part of the child television serving as a terminal with respect to the parent television by controlling the parent television in order to select and output the selected video/audio signals to the child television.

### BACKGROUND OF THE INVENTION

1. Field of the Invention

The present invention relates to a television serving system capable of sending video/audio signals to terminals, and more particularly, to a television serving system having a parent television connect to at least one child television through the bi-directional signal transmission mechanism, therefore having both the parent and child televisions broadcast video/audio signals and enabling the parent television to control video/audio signals supposed to be broadcasted on the part of the child television.

2. Description of the Prior Art

Please refer to FIG. 1 of a schematic diagram showing a conventional television having parent/child graphics thereon. The development of television 1 advances from black/white image outputting to color image one and the quality of the outputting image improves from low resolution to high resolution accordingly. Along with the great leap of the development of digital technology, the most advanced television enables viewers to view two (or more) channels (programs) simultaneously with the function of displaying parent/child (splitting) graphics on the same display screen at the same time. Additionally, the television would be able to receive video/audio signals outputted from other video/audio devices, integrating video/audio signals together and thus serving as a multi-function home appliance.

Please refer to FIG. 2 of a block diagram showing a conventional television. The conventional television 1 includes a video/audio signal processing module 14 connected to an outside video/audio device (not shown) in order to receive a video/audio signal. Meanwhile, a video/audio signal controller 12 is connected to the video/audio signal processing module 14 to control the module 14 to process the video/audio signals. The processed video/audio signals are transmitted to a display unit 18 through a resolution adjusting unit 16 connected to the video/audio signal processing module 14. The video/audio signal processing module 14 employs a multi-channel converter to set and select conversion outputs of the video/audio signals, a comb filter for differentiating signals representing the brightness from signals representing the color in order to weed out noises accompanying with video/audio signals, and a video signal decoder for decoding the video/audio signals and then outputting the decoded video/audio signals to the resolution adjusting unit 16. Current television programs are rated for the purpose of providing viewers' discretions. However, the program rating system alone still cannot block juveniles from viewing some “inappropriate” programs and therefore the user-end program decoder kicks in for decoding encoded programs. But because the program decoder is merely supposed to block restricted programs from juveniles and can not deal with programs supposed to be appropriate but still includes some content not that appropriate from the standpoint of juveniles. Plus the program decoder is accessible with ease, undermining the effect of blocking inappropriate TV programs from juveniles and younger children.

### SUMMARY OF THE INVENTION

It is therefore a primary objective of the present invention to provide a television serving system capable of sending video/audio signals to terminals thereof. The present invention television serving system includes a parent television connected to at least one child television through bi-directional signal transmission mechanism that renders parent and child televisions be capable of broadcasting video/audio signals and the parent television is capable of restricting programs broadcasted on the part of the child television.

In accordance with the claimed invention, the present television serving system capable of sending video/audio signals to terminals includes a parent television connecting to a video/audio signal broadcasting device and receiving at least one video/audio signal outputted from the video/audio signal broadcasting device, a child television, and a signal transmission interface connected to the parent television and the child television and serving as a video/audio signal transmission channel between the parent television and the child television. Therefore, parents would be able to simply control the parent television in order to select and output the selected video/audio signals to the child television, and thus viewers of the child television are only capable of viewing and hearing these “selected” video/audio signals.

It is an advantage of the present invention that parents would be able to control programs broadcasted on the child television by controlling the parent television of the serving system in order to advance the purpose of preventing their own kids from viewing inappropriate programs.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram showing a conventional television having parent/child graphics thereon.

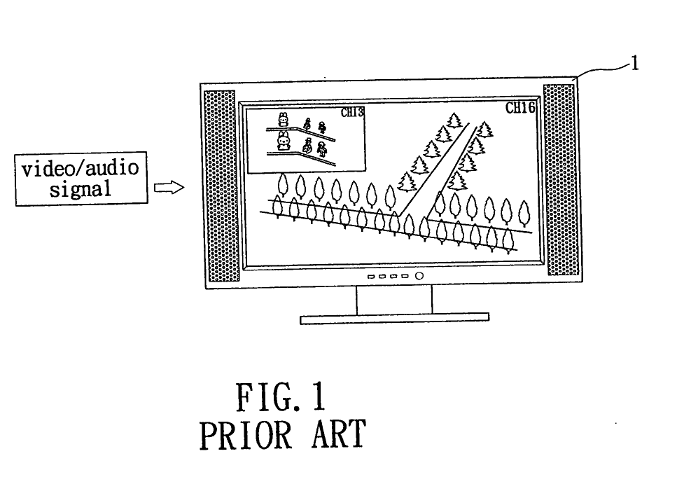

FIG. 2 is a block diagram showing a conventional television.

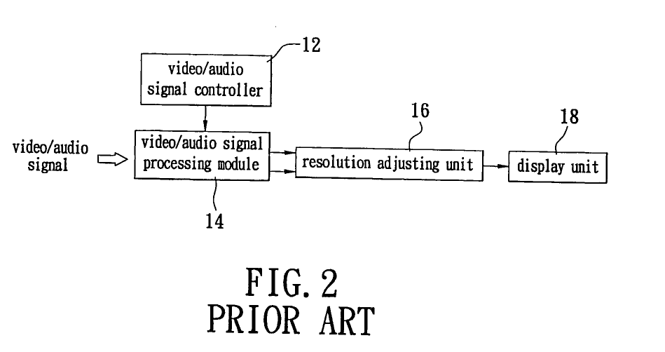

FIG. 3 is a schematic diagram showing a television serving system according to the present invention.

FIG. 4 is a block diagram showing a present invention television serving system having one parent television corresponding to one child television.

FIG. 5 is a block diagram showing another present invention television serving system having one parent television corresponding to at least one child television.

### DETAILED DECRIPTION OF THE PREFERRED EMBODIMENT

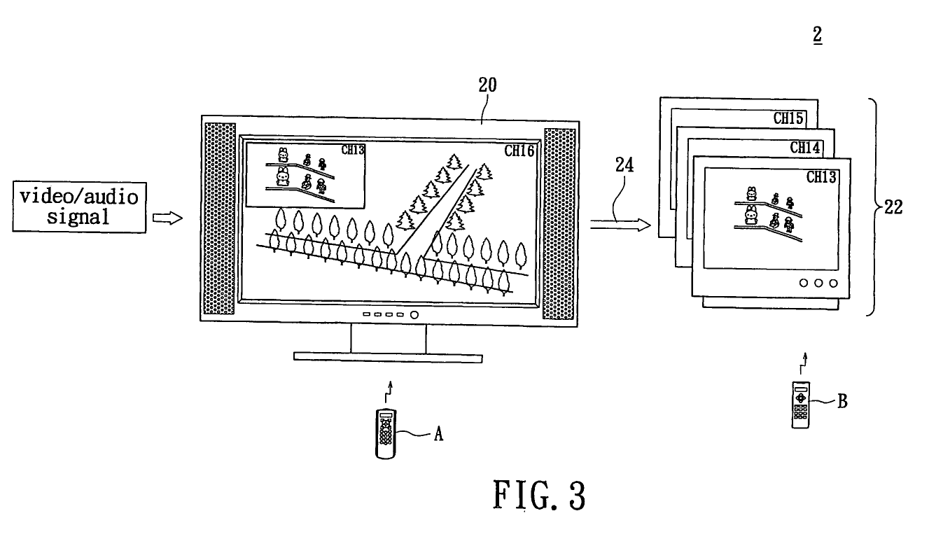

Please refer to FIG. 3 of a schematic diagram showing a television serving system according to the present invention. A television serving system 2 includes a parent television 20 connecting to at least one child television 22 through a bi-directional signal transmission interface 24 wherein signals for programs are capable of being broadcasted on the part of parent and child televisions 20 and 22. A controller A controls programs broadcasted on the part of the child television 22 as well controls the parent television 20. Another controller B is for controlling the child television 22 so that the child television 22 only serves as a receptor receiving signals (programs) selected by and outputted from the parent television.

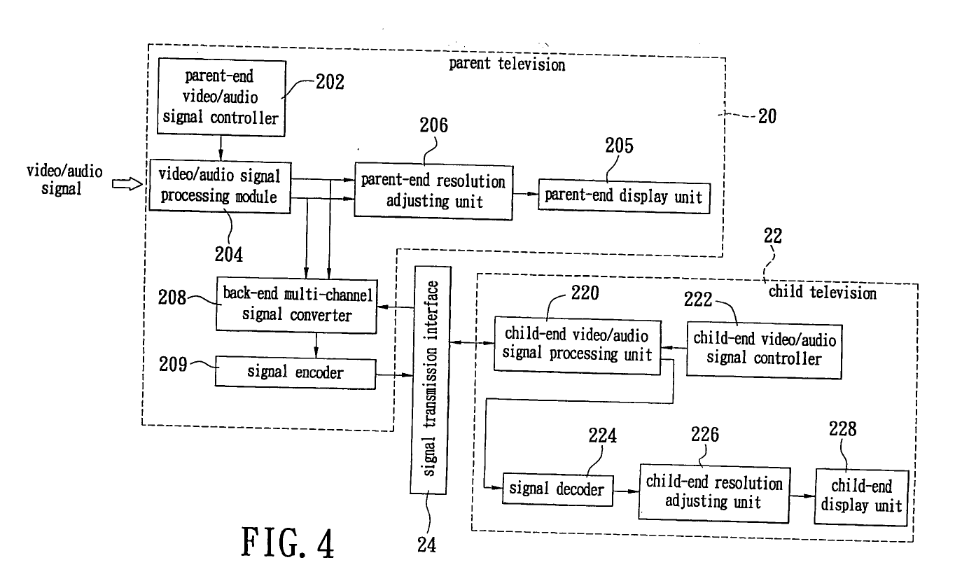

Please refer to FIG. 4 of a block diagram showing a television serving system having one parent television corresponding to one child television. The present invention television serving system includes a parent television 20, a child television 22 and a signal transmission interface 24. The parent television 20 connects to a video/audio signal broadcasting device 3 through a video/audio signal processing module 204 in order to obtain video/audio signals outputted from the video/audio signal broadcasting device 3. The video/audio signal broadcasting device 3 would be a digital video disc player (DVD player) or a video cassette recorder (VCR). The video/audio signal processing module 204 includes a front-end multi-channel signal converter (not shown) connected to the video/audio signal broadcasting device 3 and a parent-end video/audio signal controller 202. The parent-end video/audio signal controller 202 controls the front-end multi-channel signal converter so as to set up and select video/audio signals going to be outputted to a parent-end resolution adjusting unit 206. The selected video/audio signals are further transmitted to a back-end multi-channel signal converter 208. The video/audio signal processing module 204 further includes a comb filter (not shown) connected to the front-end multi-channel signal converter for differentiating signals representing the brightness from signals representing the color in order to weed out noises accompanying with video/audio signals. The video/audio signal processing module 204 further includes a video signal decoder (not shown) connected to the comb filter and the parent-end resolution adjusting unit for decoding video/audio signals and transmitting the decoded video/audio signals to the parent-end resolution adjusting unit 206. The parent-end adjusting unit 206 receives the decoded video/audio signals and adjusts the resolution thereof and that the decoded and resolution-adjusted video/audio signals will be displayed on a parent-end display unit.

FIG. 4 also shows the back-end multi-channel signal converter 208 receives selected video/audio signals outputted from the front-end multi-channel signal converter and transmits these signals to a signal encoder 209 connected thereto wherein the signal encoder 209 encodes these received video/audio signals. These encoded signals are transmitted to the child television 22 through the signal transmission interface 24. The signal transmission interface 24 preferably is a wireless signal transmission interface such as a wireless local area network (WLAN), a wired signal transmission interface such as a local area network (LAN), or a home plug.

The child television 22 connects to the signal transmission interface 24 through a child-end video/audio signal processing unit 220. Signals from the parent television 20 are transmitted to a signal decoder 224 for being decoded. These decoded signals are further transmitted to a child-end resolution adjusting unit 226 connected to the signal decoder. The child-end resolution adjusting unit 226 by definition is for adjusting the resolution of received video/audio signals and a child-end display unit 228 displays the resolution-adjusted video/audio signals. A child-end video/audio signal controller 222 connects to the child-end video/audio signal processing unit 220 for outputting a child-end controlling signal transmitted to the back-end multi-channel signal converter 208 of the parent television 20 through the signal transmission interface 24 so as to control the video/audio signals selected by and outputted from the parent television.

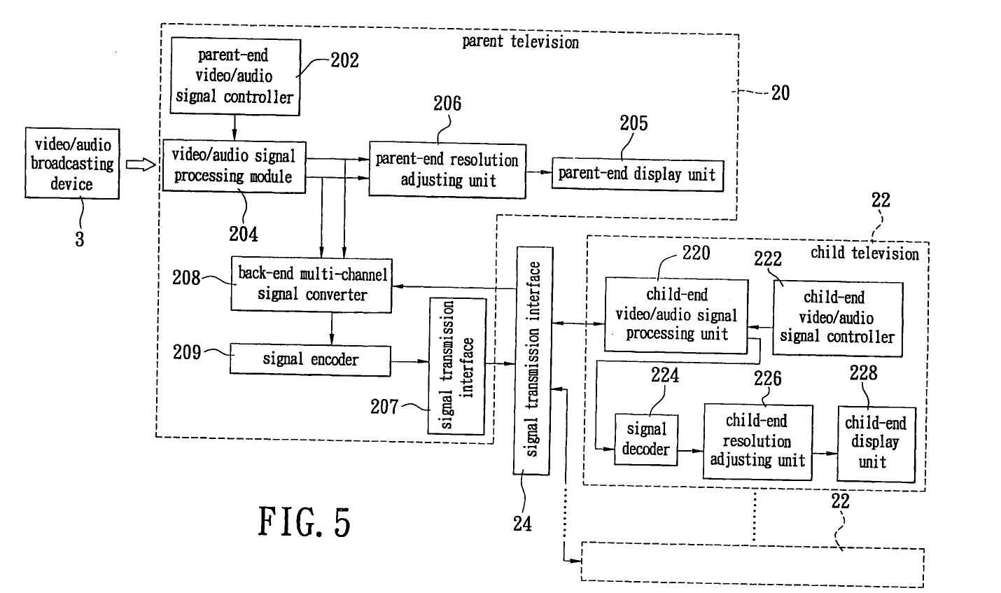

Please refer to FIG. 5 in conjunction with FIG. 4 wherein FIG. 5 shows a block diagram illustrating a television serving system having a parent television corresponding to at least one child television according to the present invention. The major difference between the televisions serving system shown in FIGS. 5 and 4 is in the case of one parent television corresponding to at least one child television at least one back-end multi-channel signal converter 208 and at least one signal encoder 209 will be employed, and these signal encoders 209 connect to the signal transmission interface 24 through a repeated multi-channel signal converter 207 and these back-end multi-channel signal converters 208 connect to the signal transmission interface 24. Moreover, in the case of one parent television corresponding to at least one child television these child televisions 22 connect simultaneously to the parent television 20 through the signal transmission interface 24. The repeated multi-channel signal converter 207 connected to these signal encoders 209 is for receiving encoded video/audio signals so as to select routes for outputting these encoded video/audio signals transmitted to corresponding child televisions, respectively, by the signal transmission interface 24, making these child televisions broadcast the same signals (programs) at the same time.

Child televisions 22 output child-end controlling signals by the child-end video/audio signal controlling unit 222 and child-end controlling signals are transmitted to corresponding back-end multi-channel signal converters of the parent television 20, respectively, through the signal transmission interface 24. Under this configuration, child televisions 22 are only capable of receiving signals selected by and then outputted from the parent television 20. Additionally, the parent television 20 controls signals converted and outputted to the parent-end resolution adjusting unit 206 by taking advantage of the parent-end video/audio signal controller 202 in order to determine which signals are going to be transmitted to these back-end multi-channel signal converters 208. Meanwhile, the present invention parent television 20 is capable of sending signals to these child televisions (terminals) 22 so as to have these child televisions 22 broadcast the same program broadcasted by the parent television 20.

In contrast to the prior art, the present invention provides a television serving system allowing parents to control programs going to be displayed on the part of child televisions by controlling the parent television directly. Therefore programs displayed on the part of child televisions are completely under the control of parents so as to prevent their juveniles or younger kids from some inappropriate programs.

Those skilled in the art will readily observe that numerous modifications and alterations of the device may be made while retaining the teachings of the invention. Accordingly, the above disclosure should be construed as limited by the metes and bounds of the appended claims.

What is claimed is:

1. A television serving system capable of sending video/audio signals to terminals, comprising:
a parent television connecting to a video/audio signal broadcasting device and receiving at least one video/audio signal outputted from the video/audio signal broadcasting device;
a child television; and
a signal transmission interface connected to the parent television and the child television and serving as a video/audio signal transmission channel between the parent television and the child television;
thereby controlling the parent television in order to select and output the selected video/audio signals to the child television and that viewers of the child television are capable of viewing and hearing these video/audio signals.

2. The television serving system in claim 1 wherein the parent television further comprises a video/audio signal processing module connected to the video/audio signal broadcasting device for obtaining and processing the video/audio signals, a parent-end resolution adjusting unit connected to the video/audio signal processing module for receiving the processed video/audio signals and adjusting the resolution thereof, a parent-end display unit connected to the parent-end resolution adjusting unit for displaying the video/audio signals, a back-end multi-channel signal converter connected to the video/audio signal processing module for selecting and then outputting the video/audio signals, and a signal encoder connected to the back-end multi-channel signal converter and the signal transmission interface for receiving and encoding the video/audio signals and transmitting the encoded video/audio signals through the signal transmission interface to the child television.

3. The television serving system in claim 2 wherein the video/audio signal processing module further comprises a front-end multi-channel signal converter connected to the video/audio signal broadcasting device and a parent-end video/audio signal controller for being controlled by the parent-end video/audio signal controller in order to select and output the converted video/audio signals to the back-end multi-channel signal converter, a comb filter connected to the front-end multi-channel signal converter for differentiating signals representing the brightness from signals representing the color in order to weed out noises along with the video/audio signals, and a video signal decoder connected to the comb filter and the parent-end resolution adjusting unit for decoding the video/audio signals and transmitting the decoded video/audio signals to the parent-end resolution adjusting unit.

4. The television serving system in claim 1 wherein the child television further comprises a child-end video/audio signal processing unit connected to the signal transmission interface for receiving and processing the video/audio signals outputted from the parent television, a signal decoder for decoding the received video/audio signals, a child-end resolution adjusting unit connected to the signal decoder for adjusting the resolution of the decoded video/audio signals, and a child-end display unit connected to the child-end resolution adjusting unit for displaying the video/audio signals.

5. The television serving system in claim 4 further comprising a child-end video/audio signal controller connected to the child-end video/audio signal processing unit for outputting a child-end controlling signal to the back-end multi-channel signal converter of the parent television through the signal transmission interface in order to select the video/audio signals supposed to be outputted to the child television.

6. The television serving system in claim 1 wherein the signal transmission interface is a wireless signal transmission interface.

7. The television serving system in claim 6 wherein the wireless signal transmission interface is a wireless local area network.

8. The television serving system in claim 1 wherein the signal transmission interface is a wired signal transmission interface.

9. The television serving system in claim 8 wherein the wired signal transmission interface is a local area network (LAN).

10. The television serving system in claim 8 wherein the wired signal transmission interface is a home plug.

11. A television serving system capable of sending video/audio signals to terminals, comprising:
a parent television connecting to a video/audio signal broadcasting device and receiving at least one video/audio signal outputted from the video/audio signal broadcasting device;
at least one child television; and
a signal transmission interface connected to the parent television and the child television and serving as a video/audio signal transmission channel between the parent television and the child television;
thereby, controlling the parent television in order to select and output the selected video/audio signals to the child television and thus viewers of the child television are capable of viewing and hearing these video/audio signals.

12. The television serving system in claim 11 wherein the parent television further comprises a video/audio signal processing module connected to the video/audio signal broadcasting device for obtaining and processing the video/audio signals, a parent-end resolution adjusting unit connected to the video/audio signal processing module for receiving the processed video/audio signals and adjusting the resolution thereof, a parent-end display unit connected to the parent-end resolution adjusting unit for displaying the video/audio signals, at least one back-end multi-channel signal converter connected to the video/audio signal processing module for selecting and then outputting the video/audio signals, at least one signal encoder connected to the back-end multi-channel signal converter and the signal transmission interface for receiving and encoding the video/audio signals, and a repeated multi-channel signal converter connected to the signal encoder for receiving the encoded video/audio signals, selecting routes of the outputted encoded video/audio signals, and outputting the selected outputted video/audio signals to the child television through the signal transmission interface.

13. The television serving system in claim 12 wherein the video/audio signal processing module further comprises a front-end multi-channel signal converter connected to the video/audio signal broadcasting device and a parent-end video/audio signal controller for being controlled by the parent-end video/audio signal controller in order to select and output the converted video/audio signals to the back-end multi-channel signal converter, a comb filter connected to the front-end multi-channel signal converter for differentiating signals representing the brightness from signals representing the color in order to weed out noises along with the video/audio signals, and a video signal decoder connected to the comb filter and the parent-end resolution adjusting unit for decoding the video/audio signals and transmitting the decoded video/audio signals to the parent-end resolution adjusting unit.

14. The television serving system in claim 11 wherein the child television further comprises a child-end video/audio signal processing unit connected to the signal transmission interface for receiving and processing the video/audio signals outputted from the parent television, a signal decoder for decoding the received video/audio signals, a child-end resolution adjusting unit connected to the signal decoder for adjusting the resolution of the decoded video/audio signals, and a child-end display unit connected to the child-end resolution adjusting unit for displaying the video/audio signals.

15. The television serving system in claim 14 further comprising a child-end video/audio signal controller connected to the child-end video/audio signal processing unit for outputting a child-end controlling signal to the back-end multi-channel signal converter of the parent television through the signal transmission interface in order to select the video/audio signals supposed to be outputted to the child television.

16. The television serving system in claim 11 wherein the signal transmission interface is a wireless signal transmission interface.

17. The television serving system in claim 16 wherein the wireless signal transmission interface is a wireless local area network.

18. The television serving system in claim 11 wherein the signal transmission interface is a wired signal transmission interface.

19. The television serving system in claim 18 wherein the wired signal transmission interface is a local area network (LAN).

20. The television serving system in claim 18 wherein the wired signal transmission interface is a home plug.
